(19) United States
(12) Patent Application Publication
(10) Pub. No.: US 2008/0022212 A1
(43) Pub. Date: Jan. 24, 2008

(54) System And Method For Generating A Custom Default User Interface On A Document Processing Device

(75) Inventors: Marianne KODIMER, Huntington Beach, CA (US); Andrey Savov, Fullerton, CA (US); Michael Yeung, Mission Viejo, CA (US); Harpreet Singh, Orange, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/459,521

(22) Filed: Jul. 24, 2006

(51) Int. Cl. G06F 3/00

(52) U.S. Cl. 715/744

(57) ABSTRACT

The subject application is directed to a system and method for generating a customized user interface. Following the receipt of user login data, a user is prompted to select a first level of operations associated with a document processing device. Thereafter, the user is prompted to select, via an associated user-interface, a subsequent level corresponding to a preceding level. User selection of a document processing function corresponding to an option of a previous level is then received and stored in association with the received user login data. Thereafter, a customized user interface is generated in accordance with the login data and the function data.

### BACKGROUND OF THE INVENTION

The subject application is directed to a system and method for generating a customized user interface. More particularly, the subject application is directed to a system and method for efficiently and effectively isolating one or more user-specified, commonly used document functions so as to be readily available to a use for future document processing operations. However, it is to be appreciated that the subject teachings are applicable to any user interface for which a customized display of a frequently used or readily accessible functionality selection is desirable.

Many devices currently employ user interfaces to allow for selection and control of devices, such as document processing devices. By way of example, many office machines, such as copiers, printers, scanners, or facsimile machines, as well as multifunction peripherals that include more than one of these functions, employ a keyboard and display or a touch screen display. Conventional user interfaces will employ a preset, hierarchical display of document functions. Complex functions frequently require forward, or forward and backward, navigation among various levels.

Due to their complexity, earlier systems are prone to selection of incongruous functionality, such as selection of one sided copying or printing, followed by a selection for stapling in two sided booklet form. Such inconsistent choices are likely to result in an unexpected document output format. Additionally, many users have standard operations that are performed frequently by each particular user. In a standard system, a user would be required to navigate and select a combination of functions each time the user accesses a device, such as a printer.

It would be desirable to have a system and method that allow for efficient selection of a frequently used function that is specified by a user, while making that function readily available for subsequent use by that user.

### SUMMARY OF THE INVENTION

In accordance with the subject application, there is provided a system and method for generating a customized user interface.

Further, in accordance with subject application, there is provided a system and method for efficiently and effectively isolating one or more user-specified, commonly used document functions so as to be readily available to a use for future document processing operations.

Still further, in accordance with the subject application, there is provided a system for generating a customized user interface. The system comprises means adapted for prompting an associated user, via a user interface associated with a document processing device, with data representative of a first level of operations available on the document processing device, wherein the first level of operations includes a plurality of first level document processing options. The system also includes means adapted for receiving first level selection data from the associated user, via the user interface, which first level selection data corresponds to a selected one of the plurality of first level document processing options. The system further includes means adapted for prompting the associated user, via the interface, with at least one subsequent level of document processing options available on the associated document processing device, wherein the at least one subsequent level of options correspond to a previous level selection data. The system also comprises means adapted for receiving, via the interface, function data representative of at least one document processing function of the document processing device, which function data corresponds to an option of a previous level of options corresponding thereto. The system further comprises storage means adapted for storing the function data, means adapted for receiving login data from the associated user, and means adapted for generating a customized document processing operation control display corresponding to the function data and login data.

In one embodiment, the storage means further comprises means adapted for storing option data corresponding to each level of document processing operation. The option data is hierarchically interrelated such that each subsequent level of options is limited in accordance with constraints associated with previously received level selection data.

In another embodiment, the system also includes means adapted for receiving input device data representative of at least one of an electronic document source characteristic and output device data representative of a characteristic of the document processing device. The system further includes means adapted for selecting data representative of at least one level of operations in accordance with at least one of the input device data and the output device data. Preferably, the storage means of such system includes means adapted for storing option data corresponding to each level of document processing operation, which option data is hierarchically interrelated such that each subsequent level of options is limited in accordance with constraints associated with previously received level selection data.

In a further embodiment, the user interface is comprised of a touch screen interface and wherein the customized document processing operation control display includes a virtual key disposed thereon. Preferably, the system also includes means adapted for communicating data representative of the customized document processing operation control display, via an associated network, for generation of a display of at least a second associated document processing device.

Still further, in accordance with the subject application, there is provided a method for generating a customized user interface in accordance with the system described above.

Still other advantages, aspects and features of the present invention will become readily apparent to those skilled in the art from the following description wherein there is shown and described a preferred embodiment of this invention, simply by way of illustration of one of the best modes best suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject invention is described with reference to certain figures, including:

FIG. 1 is an overall diagram of the system for generating a customized user interface according to the subject application;

FIG. 2 is a block diagram illustrating controller hardware for use in the system for generating a customized user interface according to the subject application;

FIG. 3 is a functional block diagram of the controller for use in the system for generating a customized user interface according to the subject application;

FIG. 4 is a flowchart illustrating the method for generating a customized user interface according to the subject application; and

FIG. 5 is a flowchart illustrating the method for generating a customized user interface according to the subject application.

### DETAILED DESCRIPTION OF THE PREFERRED EMBODIMENT

The subject application is directed to a system and method for customizing user interfaces on a document processing device. In particular, the subject application is directed to a system and method for efficiently and effectively isolating one or more user-specified, commonly used document functions so as to be readily available to a use for future document processing operations. More particularly, the subject application is directed to a system and method for generating a customized document processing control display on an associated document processing device that provides a user with the ability to easily access functions specifically designated by the user.

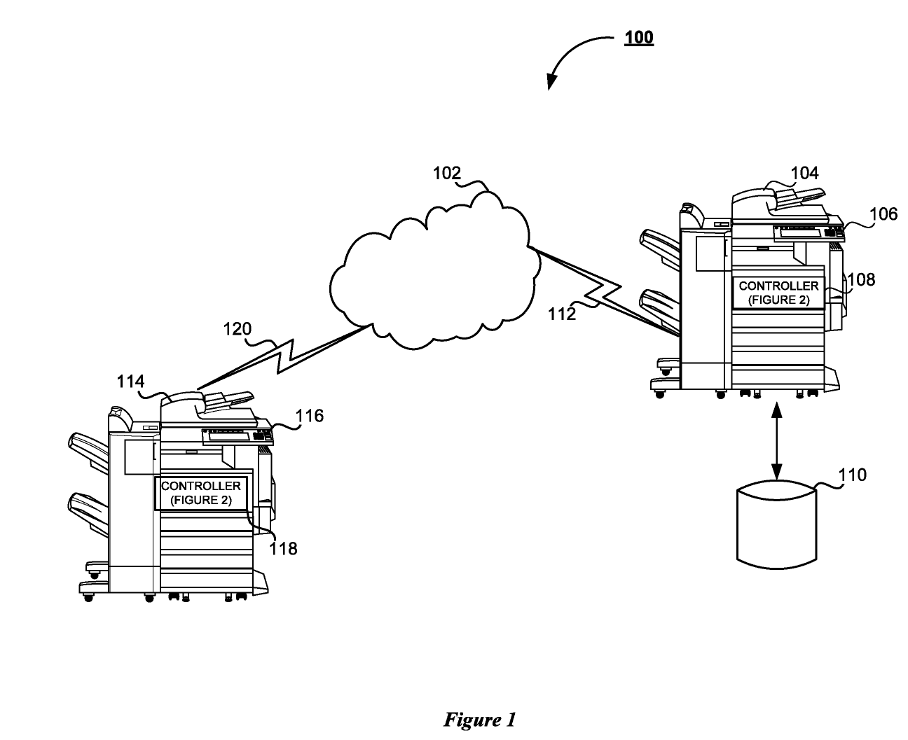

Turning now to FIG. 1, there is shown an overall diagram of the system 100 for generating a customized user interface in accordance with the subject application. As shown in FIG. 1, the system 100 employs a distributed computing environment, represented as a computer network 102. It will be appreciated by those skilled in the art that the computer network 102 is any distributed communications environment known in the art capable of enabling the exchange of data between two or more electronic devices. Those skilled in the art will further appreciate that the network 102 is any computer network known in the art including, for example and without limitation, a virtual area network, a local area network, a personal area network, the Internet, an intranet, a wide area network, or any suitable combination thereof. Preferably, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms.

The system 100 depicted in FIG. 1 further includes a first document processing device 104, represented as a multifunction peripheral device, suitably adapted to perform a variety of document processing operations. The skilled artisan will understand that such document processing operations include, for example and without limitation, copying, scanning, electronic mail, document management, facsimile, printing, and the like. Suitable commercially available document processing devices include, but are not limited to, the Toshiba e-Studio Series Controller. In one embodiment, the first document processing device 104 is suitably equipped to receive a plurality of portable storage media, including without limitation, Firewire drive, USB drive, SD, MMC, XD, Compact Flash, Memory Stick, and the like. In the preferred embodiment of the subject application, the first document processing device 104 further includes an associated user-interface 106, such as a touch-screen interface, an alpha-numeric interface, an LCD display, or the like, via which an associated user is able to interact directly with the document processing device 104. Preferably, the user-interface 106 is suitably adapted to display a graphical user interface associated with the operation of the first document processing device 104.

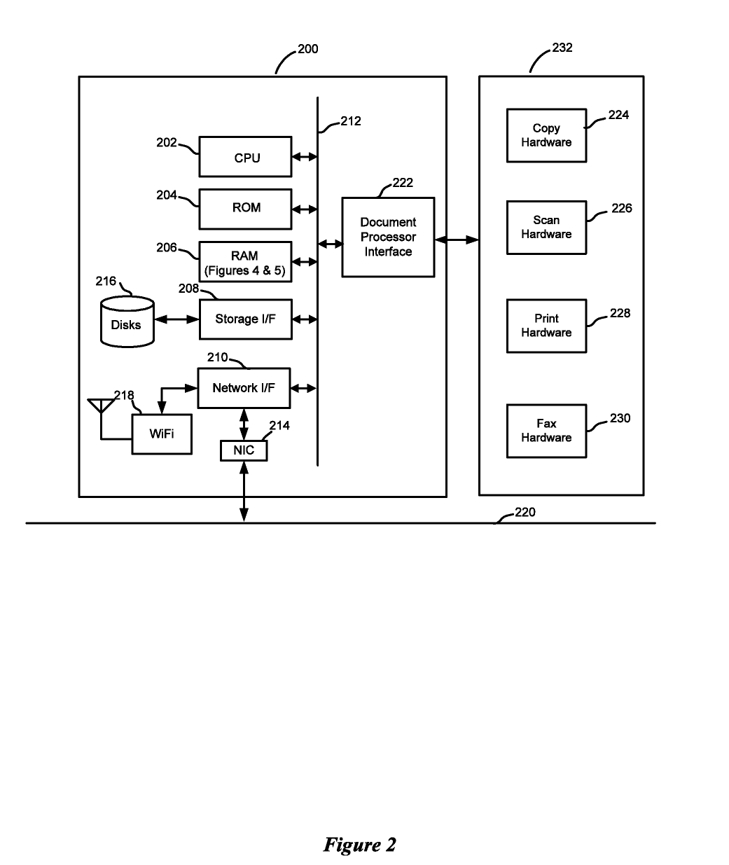

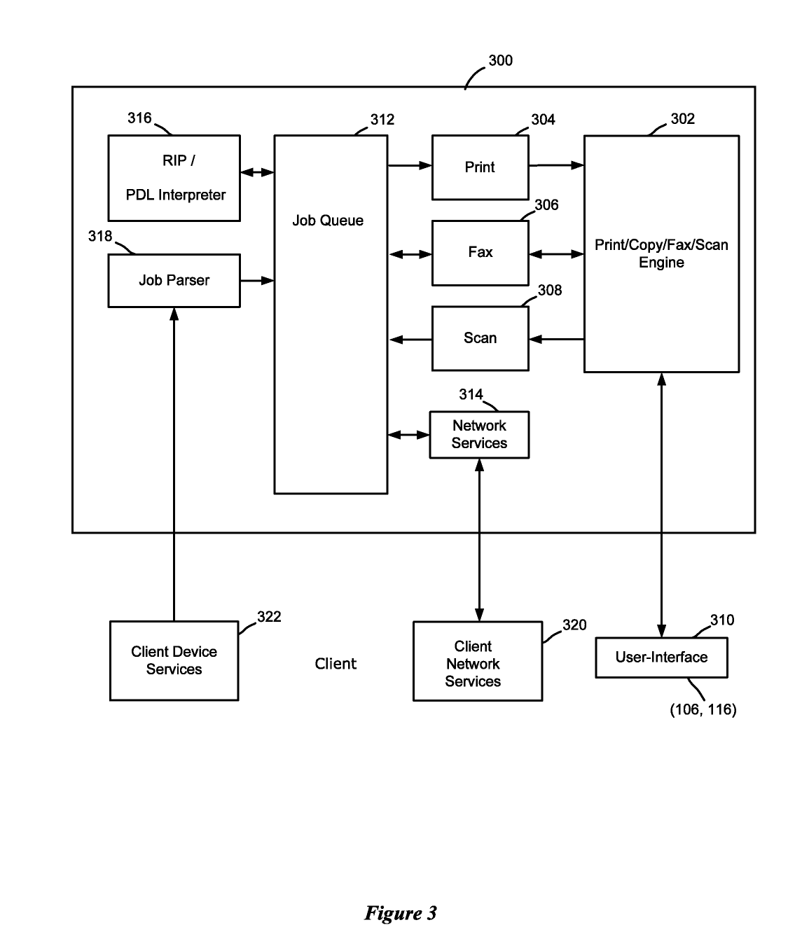

In accordance with the subject application, the first document processing device 104 further incorporates a controller 108, suitably adapted to facilitate the operations of the first document processing device 104, as will be understood by those skilled in the art. Preferably, the controller 108 is embodied as hardware, software, or any suitable combination thereof, configured to control the operations of the associated document processing device 104, control the display of images via the user-interface 106, customize a graphical user interface, and the like. The functioning of the controller 108 will better be understood in conjunction with the block diagrams illustrated in FIGS. 2 and 3, explained in greater detail below.

Communicatively coupled to the first document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store information relative to the customized user-interface screens, home pages, settings, or the like, associated with a particular user's identification information. In addition, the data storage device 110 is further capable of storing some or all of a particular customized graphical user-interface associated with an individual user. It will be appreciated by those skilled in the art that while illustrated in FIG. 1 as being a separate component of the system 100, the data storage device 110 is capable of being implemented as internal storage of the document processing device 104, such as, for example and without limitation, an internal hard disk drive, or the like.

Preferably, the first document processing device 104 is communicatively coupled to the computer network via a suitable communications link 112. As will be understood by those skilled in the art, suitable communications links include, for example and without limitation, WiMax, 802.11a, 802.11b, 802.11 g, 802.11(x), Bluetooth, the public switched telephone network, a proprietary communications network, infrared, optical, or any other suitable wired or wireless data transmission communications known in the art.

In accordance with one aspect of the subject application, the system 100 illustrated in FIG. 1 further includes a second document processing device 114, represented as a multifunction peripheral device. Similar to the first document processing device 104, the skilled artisan will appreciate that the second document processing device 114 is capable of performing a variety of document processing operations, including, for example and without limitation, document management, facsimile, printing, copying scanning, electronic mail, and the like. Suitable commercially available document processing devices include, but are not limited to, the Toshiba e-Studio Series Controller. In one embodiment of the subject application, the second document processing device 114 includes an associated user-interface 116, such as a touch-screen interface, an alpha-numeric interface, an LCD display, or the like, via which an associated user is able to interact directly with the second document processing device 114. Preferably, the user-interface 116 is suitably adapted to display a graphical user interface associated with the operation of the second document processing device 114. The skilled artisan will appreciate that the second document processing device 114 is capable of being equipped to receive a plurality of portable storage media, such as, for example and without limitation, Compact Flash, Memory Stick, MMC, XD, SD, USB drives, Firewire drives, and the like.

The second document processing device 114 further incorporates a controller 118, suitably configured to control operations of the document processing device 114, image display on the user-interface 116, receipt of user instructions, and the like. The skilled artisan will appreciate that the controller 118 is any hardware, software, or suitable combination thereof capable of facilitating the control of the document processing device 114 in accordance with the subject application. The functioning of the controller 118, similar to that of the controller 108, will better be understood in conjunction with the block diagrams illustrated in FIGS. 2 and 3, explained in greater detail below. Preferably, the second document processing device 114 is communicatively coupled to the computer network via a suitable communications link 120. As will be understood by those skilled in the art, suitable communications links include, for example and without limitation, WiMax, 802.11a, 802.11b, 802.11 g, 802.11(x), Bluetooth, the public switched telephone network, a proprietary communications network, infrared, optical, or any other suitable wired or wireless data transmission communications known in the art.

Turning now to FIG. 2, illustrated is a representative architecture of a suitable controller 200 on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with bus 212 is a document processor interface 222. Document processor interface 222 suitably provides connection with hardware to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system is accomplished on a suitable document processing device 104 that includes the controller 200 of FIG. 2 as an intelligent subsystem associated with a document processing device. In the illustration of FIG. 3, controller function 300 in the preferred embodiment, includes a document processing engine 302. A suitable controller functionality is that which is incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

In operation, the controller 108 associated with the first document processing device 104 receives login data from an associated user via the user-interface 106. Preferably, this login data includes, for example and without limitation, a user ID/password, biometric data, personal identification number, a smart card, or the like. In accordance with the customization aspect of the subject application, the controller 108 associated with the first document processing device 104 then prompts, using a graphical user interface displayed on the user-interface 106, the user to select a first level operation. Preferably, the first level operation corresponds to a base function or service capable of performance by the associated document processing device 104, including, for example and without limitation, scanning, facsimile, copying, printing, electronic mailing, or the like. The skilled artisan will appreciate that these operations are representative of the top level functionality associated with the document processing device 104, wherein each top level has one or more subsequent levels corresponding to further associated services, options, or the like. The controller 108, via the user-interface 106, receives first level selection information from the associated user and thereafter prompts the user to select a subsequent level corresponding to the first level. The skilled artisan will appreciate that the controller 108, determines the sub-functions associated with the first level and uses these subsequent levels to further customize the user interface.

The controller 108 then prompts the user to select a document processing function corresponding to the previous level. The controller 108 then receives user selection of a document processing function corresponding to an option of a previous level. The function data, corresponding to all selections made by the user is then stored by the controller 108 associated with the document processing device 104 via the data storage device 110. Preferably, the function data is stored in association with the user login information. Thereafter, the controller 108, via the user-interface 106, suitably generates a customized document processing operation control display, e.g., a graphical user interface for controlling the operations of the associated first document processing device 104.

In one embodiment of the subject application, the controller 108 associated with the first document processing device 104 receives user identification data representing a login via the user-interface 106. Preferably, this subject application is implemented in the form of a “Wizard”, as will be understood by those skilled in the art, which facilitates the configuration of settings using a series of prompts and user input. A determination is then made by the controller 108 whether the user associated with the login data has previously created a customized display. This determination is made by the controller 108 accessing the associated data storage device 110 and searching for function data associated with the received login data. When such a link is located, the function data is retrieved by the controller 108 and used to generate the customized user interface via the user-interface 106. When no such link is located in the data storage device 110, the controller 108 prompts the user to create a customized user interface. When the user elects not to create a customized user interface, a suitable default document processing control display is illustrated on the user-interface 106 and the operation terminates.

When the user selects the creation of a customized user interface, the controller 108 first determines whether any characteristic data has been received. That is, the controller 108 determines whether input device data representing an electronic source characteristic or output device data representing a characteristic of a document processing device has been received. The skilled artisan will appreciate that suitable characteristic data includes, for example and without limitation, processing capabilities, access rights, toner capabilities, output media, size limitations, or the like. When such characteristic data is received, the controller 108 determines the first level of functions to be displayed based upon this characteristic data. Thus, the controller 108 analyzes the device data and determines which functionalities of the document processing device 104 are compatible with this data. The user is then prompted to select a first level operation from this constrained listing of functions provided by the controller 108. When no characteristic data has been received by the controller 108, the user is prompted to select a first level operation from among those operations capable of performance by the first document processing device 104. The skilled artisan will appreciate that the subject application is capable of limiting the first level operations based upon a variety of factors including, for example and without limitation, user access rights, network policies, or the like.

The controller 108 then receives user selection data representing the desired first level function, for example the copy function. The controller 108 then retrieves a sublevel of functionality associated with the copy function and prompts the user to select one of the subsequent levels. Continuing with the copy selection, the subsequent level includes the options of adjusting image quality, image editing, page manipulation/finishing, sheet inserts, and the like. The selection of one of these subsequent level options is then received by the controller 108 and stored in a hierarchical manner with the preceding main function. When the user has selected a desired option, e.g., the page manipulation/finishing option, the controller 108 determines whether any subsequent levels are available. That is, the controller 108, based upon the subsequent level selected, determines whether that level has any additional sublevels left.

Thus, when the user selects the page manipulation/finishing option, the user is prompted to select a subsequent level of options corresponding to the previously selected sublevel. For example, when the user has selected the page manipulation/finishing option, a subsequent level of options associated with the selected option are displayed, e.g., N-Up, magazine sort, split book pages, book to tablet, and the like. It will be appreciated by those skilled in the art that only those options supported by the user's previous selections will be displayed, thereby avoiding non-compatible options. Thus, certain options shown as examples above are not offered to the user as these options would contradict the higher-level functions selected. When no subsequent levels remain, the user is prompted to select settings or function options corresponding to the last selected level. That is, when the user has selected the magazine sort option, the user is prompted to select magazine sort settings. The controller 108 then receives this user selection of a document processing function, including all previous levels and settings and stores the function data in the data storage device 110 associated with the received user login data.

The controller 108 thereafter generates a customized document processing operation control display, or user-interface, based upon the function data. The customized document processing operation control display is then associated with a virtual key, such as an icon, blank hard-wired button, or the like. Thus, the skilled artisan will appreciate that the virtual icon is thereafter displayed to the user at subsequent logons by the user, enabling the user to quickly proceed to the desired operation, without having to progress through a successive series of screens displayed on the user-interface 106.

In accordance with one embodiment of the subject application, the second document processing device 114, upon receipt of user login data, is capable of requesting the function data via the computer network 102. That is, upon login of the user at the second document processing device 114, the controller 118 requests function data from the first document processing device 104 corresponding to the user's customized user interface. When no such request is received, the operation terminates. When such a request is received, the first document processing device 104 transmits the stored user interface data to the second document processing device 114 via the computer network 102.

In accordance with one aspect of the subject application, the system described above reflects a query based system and user interface to help a user create a customized user interface, in the form of a virtual key, or task button, preset, template, or the like, for the document processing device 104. Preferably, the task button is defined as a button on the document processing device 104 that serves as a shortcut to a function or group of settings. One or more task buttons reside on the graphical user interface, such as the first screen displayed to the user upon logon and when pressed, recalls the settings previously selected by the user. The task button allows the user to eliminate several steps or user actions required to access a specific functionality and therefore are created by a user for common or reused settings.

This aspect provides a myriad of manners in which a task button is capable of being configured in accordance with the subject application. For example, the controller 108 is capable of providing a ‘simulator’ of the entire user interface with which the user interacts, selecting the functions as described above. In addition, the controller 108 is capable of implementing a macro approach wherein the user enters a mode to record interaction with the user interface which is subsequently associated with the task button. In the preferred embodiment, as described above, the subject application employs a task-oriented query based approach similar to a “Wizard” wherein the user is exposed to a series of screens designed to allow the user to configure the task button by viewing the minimum number of screens possible.

As will be appreciated by those skilled in the art, the use of the efficient querying of the user, whereby the fewest number of query screens are displayed to the user, is accomplished in a variety of methodologies, including, for example and without limitation, the presentation of high level mutually exclusive feature categories yielding a ‘funnel down’ approach to a setting; and/or the presentation of a task oriented approach wherein the user describes the document source or the target which are thereafter used to filter unnecessary features and show the user only features that relate to the user's task. For example, when the user is presented a screen to describe the current document, and selects one-sided print on letter size paper, a screen to describe the desired output is selected. From this screen, the user selects, 2-sided Booklet on letter paper, subsequent screens shown will be based on the high-level selection. Continuing with this example, the user will never be shown screens with questions regarding N-up, Zoom to page, Dual page, or the like, as such display would contradict the high level settings described initially. As a result, the content of screens and logical presentation will maximize efficiency in interacting with screens to configure a preset.

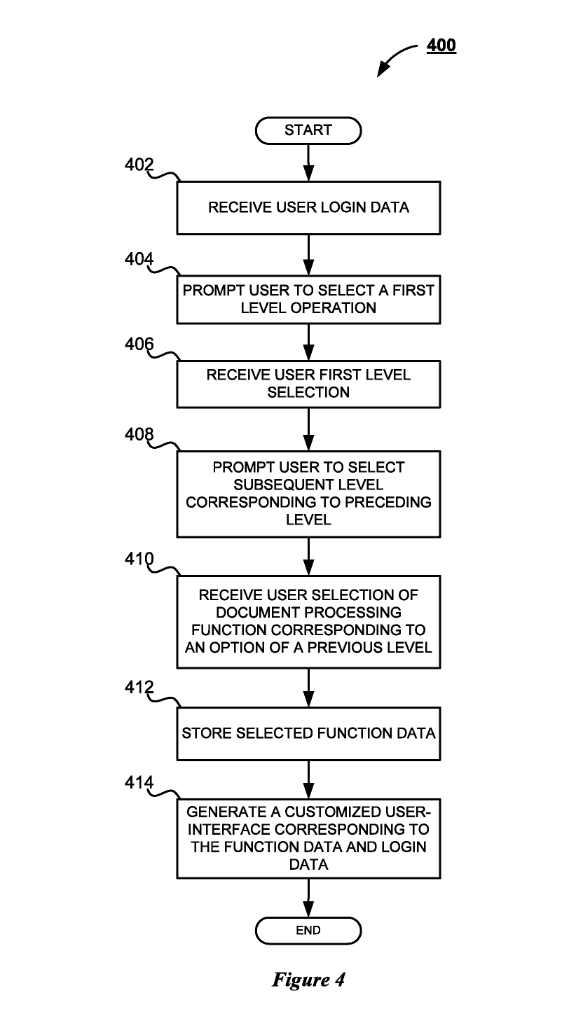

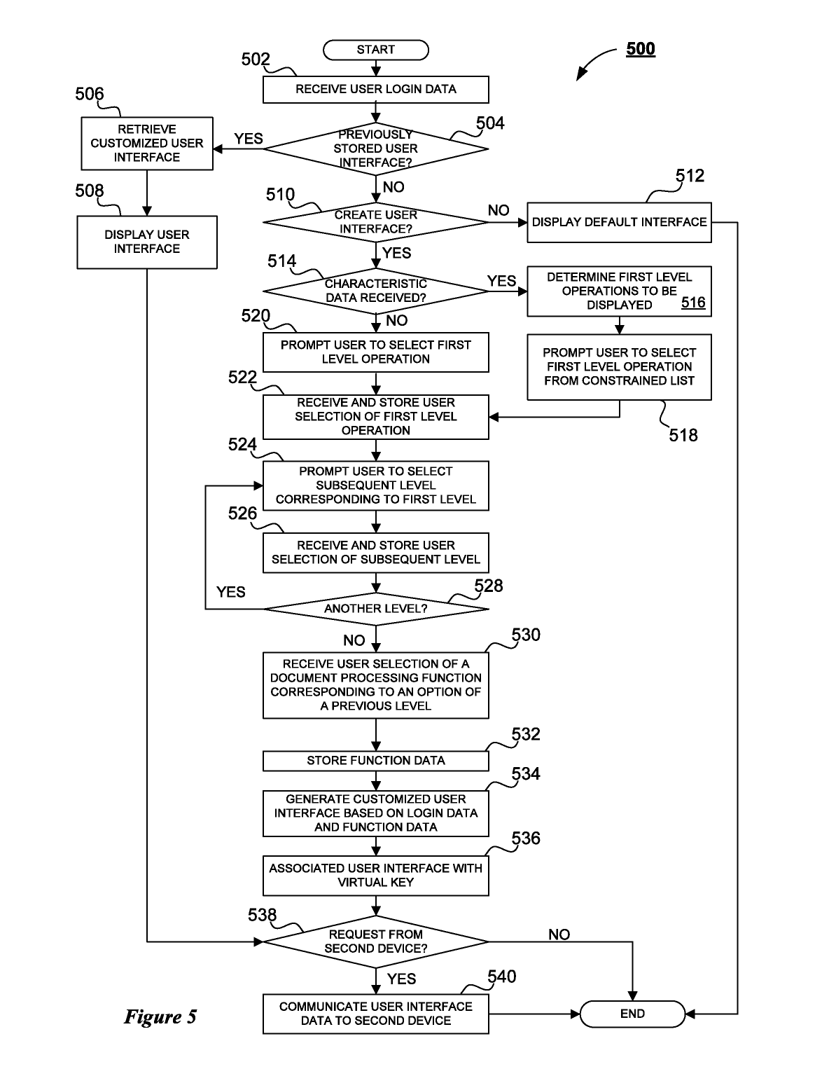

The foregoing system 100 and components described in FIG. 1, FIG. 2, and FIG. 3 will be better understood in conjunction with the methodologies illustrated in FIG. 4 and FIG. 5. Referring now to FIG. 4, there is shown a flowchart 400 illustrating a method for generating a customized user interface in accordance with the subject application. Beginning at step 402, the controller 108 associated with the first document processing device 104 receives login data from an associated user via any suitable means. Such login data is capable of including, for example and without limitation, user ID/password, biometric data, personal identification number, or the like. The controller 108, via the associated user-interface 106, prompts the user at step 404 to select a first level operation. For example, a copy operation, a scanning operation, a facsimile operation, a print operation, or the like is selected by the user. At step 406, first level selection data is received from the user corresponding to the desired main level.

Flow then proceeds to step 408, whereupon the controller 108 prompts the user to select subsequent level corresponding to the preceding level. That is, the controller 108 displays a subsequent level of operations corresponding to the preceding level selected. The controller 108 then receives, at step 410, user selection of a document processing function corresponding to an option associated with a previous level. This function data is then stored, at step 412, in the associated data storage device 110 by the controller 108. Thereafter, a customized document processing device control display, or user interface, is generated by the controller 108 at step 414 corresponding to the function data and the login data.

Turning now to FIG. 5, there is shown a flowchart 500 illustrating a preferred method for customizing a user interface in accordance with the subject application. Operation in accordance with FIG. 5 begins at step 502, whereupon user login data is received by the controller 108 associated with the first document processing device 104. A determination is then made at step 504 whether a user interface associated with the user has been previously stored. That is, the controller 108 searches the data storage device 110 for previously stored function data corresponding to the received login data. When a positive determination is made at step 504, flow proceeds to step 506, whereupon the controller 108 retrieves the customized user interface, i.e., function data, from the data storage device 110. The retrieved data is then used at step 508 to display the previously stored user interface. Flow thereafter proceeds to step 538, whereupon a determination is made whether a second document processing device 114 has requested a customized user interface. When no such request has been received, the operation terminates. When such a request has been received, the controller 108, via the first document processing device 104, communicates the customized user interface to the second document processing device 114 at step 540.

Returning to step 504, when no previously stored user interface has been located by the controller 108, flow proceeds to step 510, whereupon a determination is made whether to create a customized user interface. That is, the controller 108 determines whether the user has selected to generate a new user interface. When no such request by the user is received, flow proceeds to step 512, whereupon a default display is used. When the user desires to create a new user interface, flow proceeds to step 514, whereupon a determination is made whether characteristic data has been received. That is, the controller determines whether input device data or output device data has been received, which would limit the functionality displayed to the user. When the controller 108 has not received characteristic data, flow proceeds to step 520, whereupon the user is prompted to select a first level operation. The controller then receives the user selection of the first level operation at step 522.

Returning to step 514, when the controller 108 associated with the first document processing device 108 has received characteristic data, flow proceeds to step 516, whereupon the first level functions to be displayed to the user are determined by the controller 108 based upon the received characteristic data. The user is then prompted, at step 518, to select first level function from the list of functions constrained by the characteristic data. Operations thereafter proceed to step 522, whereupon the controller 108 associated with the first document processing device 104 receives the user selection of the first level of operation. Preferably, the first level selection data is stored in association with the received login data at step 522.

The user is then prompted at step 524, to select a subsequent level corresponding to the first selected level. Preferably, the subsequent level of options is restricted, when characteristic data has been received to reflect only those compatible options. Similarly, the controller 108 recognizes when no characteristic data has been received and all options corresponding to the selected main level are capable of being displayed. At step 526, the controller 108 receives and stores the user selection of the subsequent level options. Flow then proceeds to step 528, whereupon a determination is made whether a subsequent level, associated with the previously selected levels, remains. That is, when the selected sublevel has additional levels below, flow returns to step 524, whereupon the next subsequent level is displayed to the user for selection. When no additional levels remain, flow progresses from step 528 to step 530, whereupon the controller 108 receives user selection of a document processing function corresponding to an option associated with the previous level. That is, when no further sublevels remain, the user selects those options associated with the last sublevel, such as settings, or the like. The function data received at step 530 are then stored at step 532 in the data storage device 110 in association with the received user login data.

A customized user interface, such as a document processing operation control display, is generated at step 534 based upon the login data and the function data. At step 536, the customized user interface is associated with a virtual key, which is suitably capable of being represented as an icon on the user-interface 116. Flow then proceeds to step 538, whereupon a determination is made whether a request has been received from a second document processing device 114 for the customized user interface associated with a given user. That is, the second document processing device 114 has received user login data and queries the first document processing device 104 whether the first document processing device 104 has a customized user interface associated with the received user login data. When no such interface is located by the first document processing device 104, the method embodied in FIG. 5 is terminated and the user is able to carry out desired document processing operations on the document processing device. When such a customized user interface associated with the login data is located, flow proceeds to step 540, whereupon the user interface data is communicated to the requesting document processing device 114 via the computer network 102.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for generating a customized user interface comprising:
means adapted for prompting an associated user, via a user interface associated with a document processing device, with data representative of a first level of operations available on the document processing device, the first level of operations including a plurality of first level document processing options;
means adapted for receiving first level selection data from the associated user, via the user interface, which first level selection data corresponds to a selected one of the plurality of first level document processing options;
means adapted for prompting the associated user, via the interface, with at least one subsequent level of document processing options available on the associated document processing device, the at least one subsequent level of options corresponding to a previous level selection data;
means adapted for receiving, via the interface, function data representative of at least one document processing function of the document processing device, which function data corresponds to an option of a previous level of options corresponding thereto;
storage means adapted for storing the function data;
means adapted for receiving login data from the associated user;
means adapted for generating a customized document processing operation control display corresponding to the function data and login data.

2. The system for generating a customized user interface of claim 1 wherein the storage means further comprises means adapted for storing option data corresponding to each level of document processing operation, which option data is hierarchically interrelated such that each subsequent level of options is limited in accordance with constraints associated with previously received level selection data.

3. The system for generating a customized user interface of claim 1 further comprising:
means adapted for receiving at least one of input device data representative of an electronic document source characteristic and output device data representative of a characteristic of the document processing device; and
means adapted for selecting data representative of at least one level of operations in accordance with at least one of the input device data and the output device data.

4. The system for generating a customized user interface of claim 3 wherein the storage means further comprises means adapted for storing option data corresponding to each level of document processing operation, which option data is hierarchically interrelated such that each subsequent level of options is limited in accordance with constraints associated with previously received level selection data.

5. The system for generating a customized user interface of claim 1 wherein the user interface is comprised of a touch screen interface and wherein the customized document processing operation control display includes a virtual key disposed thereon.

6. The system for generating a customized user interface of claim 5, further comprising means adapted for communicating data representative of the customized document processing operation control display, via an associated network, for generation of a display of at least a second associated document processing device.

7. A method for generating a customized user interface comprising the steps of:
prompting an associated user, via a user interface associated with a document processing device, with data representative of a first level of operations available on the document processing device, the first level of operations including a plurality of first level document processing options;
receiving first level selection data from the associated user, via the user interface, which first level selection data corresponds to a selected one of the plurality of first level document processing options;
prompting the associated user, via the interface, with at least one subsequent level of document processing options available on the associated document processing device, the at least one subsequent level of options corresponding to a previous level selection data;
receiving from the associated user, via the interface, function data representative of at least one document processing function of the document processing device, which function data corresponds to an option of a previous level of options corresponding thereto;
storing the function data;
receiving login data from the associated user;
generating a customized document processing operation control display corresponding to the function data and login data.

8. The method for generating a customized user interface of claim 7 further comprising the step of storing option data corresponding to each level of document processing operation, which option data is hierarchically interrelated such that each subsequent level of options is limited in accordance with constraints associated with previously received level selection data.

9. The method for generating a customized user interface of claim 7 further comprising the steps of:
receiving at least one of input device data representative of an electronic document source characteristic and output device data representative of a characteristic of the document processing device; and
selecting data representative of at least one level of operations in accordance with at least one of the input device data and the output device data.

10. The method for generating a customized user interface of claim 9 further comprising the step of storing option data corresponding to each level of document processing operation, which option data is hierarchically interrelated such that each subsequent level of options is limited in accordance with constraints associated with previously received level selection data.

11. The method for generating a customized user interface of claim 7 wherein the steps of prompting an associated user and receiving input from an associated user include the steps of completing the prompting and receiving via a virtual key disposed on a touch-screen display.

12. The method for generating a customized user interface of claim 11 further comprising the step of communicating data representative of the customized document processing operation control display, via an associated network, for generation of a display of at least a second associated document processing device.

13. A computer-implemented method for generating a customized user interface comprising the steps of:
prompting an associated user, via a user interface associated with a document processing device, with data representative of a first level of operations available on the document processing device, the first level of operations including a plurality of first level document processing options;
receiving first level selection data from the associated user, via the user interface, which first level selection data corresponds to a selected one of the plurality of first level document processing options;
prompting the associated user, via the interface, with at least one subsequent level of document processing options available on the associated document processing device, the at least one subsequent level of options corresponding to a previous level selection data;
receiving from the associated user, via the interface, function data representative of at least one document processing function of the document processing device, which function data corresponds to an option of a previous level of options corresponding thereto;
storing the function data;
receiving login data from the associated user;
generating a customized document processing operation control display corresponding to the function data and login data.

14. The computer-implemented method for generating a customized user interface of claim 13 further comprising the step of storing option data corresponding to each level of document processing operation, which option data is hierarchically interrelated such that each subsequent level of options is limited in accordance with constraints associated with previously received level selection data.

15. The computer-implemented method for generating a customized user interface of claim 13 further comprising the steps of:
receiving at least one of input device data representative of an electronic document source characteristic and output device data representative of a characteristic of the document processing device; and
selecting data representative of at least one level of operations in accordance with at least one of the input device data and the output device data.

16. The computer-implemented method for generating a customized user interface of claim 15 further comprising the step of storing option data corresponding to each level of document processing operation, which option data is hierarchically interrelated such that each subsequent level of options is limited in accordance with constraints associated with previously received level selection data.

17. The computer-implemented method for generating a customized user interface of claim 13 wherein the steps of prompting an associated user and receiving input from an associated user include the steps of completing the prompting and receiving via a virtual key disposed on a touch-screen display.

18. The computer-implemented method for generating a customized user interface of claim 17 further comprising the step of communicating data representative of the customized document processing operation control display, via an associated network, for generation of a display of at least a second associated document processing device.
